(19) United States
(12) Patent Application Publication
(10) Pub. No.: US 2025/0205697 A1
(43) Pub. Date: Jun. 26, 2025

(54) HIGHLY EFFICIENT PHOTOCATALYST MATERIAL FOR DECOMPOSING ORGANIC HAZARDOUS SUBSTANCES AND METHOD FOR SYNTHESIZING SAME

(71) Applicants: Korea Institute of Energy Technology, Naju-si (KR); Korea University Research and Business Foundation, Sejong Campus, Sejong-si (KR)

(72) Inventors: Dong Han SEO, Naju-si (KR); Sun Woo KIM, Naju-si (KR); Jae Muk LIM, Naju-si (KR); Jun Sub KIM, Yongin-si, Gyeonggi-do (KR); Young Jin KIM, Daejeon (KR); Abouelanwar Ali Mahmoud Mohamed, Sejong-si (KR); Jong Min OH, Sejong-si (KR)

(21) Appl. No.: 18/988,887

(22) Filed: Dec. 20, 2024

(30) Foreign Application Priority Data
Dec. 21, 2023 (KR) 10-2023-0188465

(51) Int. Cl. B01J 37/34; B01J 21/08; B01J 35/39

(52) U.S. Cl. CPC B01J 37/349; B01J 21/08; B01J 35/39; B01J 37/343

(57) ABSTRACT

An embodiment of the disclosure provides a highly efficient photocatalyst material for decomposing organic hazardous substances, the highly efficient photocatalyst material including: silica having micropores formed; and a quantum dot substance surrounding the silica, wherein the quantum dot substance is coexistence of a TiO₂ quantum dot and a TiO₂₋ₓ quantum dot, and the X is a real number greater than 0 and less than 2.

### BACKGROUND

The disclosure relates to a highly efficient photocatalyst material for decomposing organic hazardous substances, and more specifically, to a highly efficient photocatalyst material for decomposing organic hazardous substances and a method for synthesizing the same, wherein the material exhibits high-efficiency photocatalytic performance under a wide range of light sources, including low-light and visible light, and UV-A, by utilizing silica or diatomaceous earth having micropores that cannot be used in semiconductor processes through a low-temperature and atmospheric pressure plasma synthesis method.

In the case of a TiO₂ material, a widely studied and researched representative photocatalyst material safe for the human body, photocatalytic activation occurs under a high-energy light source, UV light source, and this is a photocatalyst material that requires high energy usage to decompose harmful substances or organic substances.

In order to overcome this, various studies have been conducted to synthesize TiO₂ photocatalyst materials that are activated under visible light and increase catalytic efficiency (fast organic substance decomposition ability) by doping various TiO₂ materials with other metal elements, combining them with other expensive nano materials, or utilizing functional groups, defects, and various nanostructures of TiO₂.

However, despite these efforts, TiO₂ materials that are activated in various visible light do not have high material safety (the developed TiO₂ catalysts are quickly deactivated in visible light), and a hydrothermal synthesis method, which is the existing and widely used TiO₂ synthesis method, requires a long synthesis time of 12 to 24 hours at about 160 to 200°° C. and a large amount of metal precursors, so there are limitations in terms of process efficiency.

### RELATED ART DOCUMENT

### Patent document

Japanese Patent Registration No. 5787347

### SUMMARY

The disclosure is to overcome the above-described problems by utilizing a small amount of metal precursor, providing a remarkably fast synthesis time (less than 10 minutes), and utilizing a bio-silica material having a large amount of pores that is very inexpensive and is helpful for the environment and resource recycling economy, thereby providing an effective photocatalyst material and a synthesis method thereof that can rapidly decompose various organic hazardous substances in LEDs and fluorescent lamps including visible light and low-intensity UV-A light sources, thereby making it possible to overcome the above-described material and process limitations by one step.

The aspect of the disclosure is not limited to that mentioned above, and other aspects not mentioned will be clearly understood by those skilled in the art from the description below.

An embodiment of the disclosure provides a highly efficient photocatalyst material for decomposing organic hazardous substances.

The highly efficient photocatalyst material for decomposing organic hazardous substances according to an embodiment of the disclosure may include: silica having nanopores formed; and a quantum dot substance surrounding the silica, wherein the quantum dot substance is coexistence of a TiO₂ quantum dot and a TiO₂₋ₓ quantum dot, and the X is a real number greater than 0 and less than 2.

In addition, according to an embodiment of the disclosure, a porosity of nanopores formed in the silica may be 2 nm to 100 nm.

In addition, according to an embodiment of the disclosure, the TiO₂₋ₓ quantum dot may include an oxygen defect or a hydroxyl group (—OH).

In addition, according to an embodiment of the disclosure, the TiO₂ quantum dot may have a multi-crystal structure including a rutile crystal structure and an anatase crystal structure.

In addition, according to an embodiment of the disclosure, in the entire photocatalyst material, a ratio of the presence of the TiO₂ quantum dot and TiO₂₋ₓ quantum dot may be 2:8 to 8:2.

In addition, according to an embodiment of the disclosure, through a Ti—O—Si bond formed by bonding of the silica and the TiO_{2-X} quantum dot surrounding the silica, reduction of the TiO_{2-X} quantum dot having a defect to the TiO₂ quantum dot in an oxygen-containing environment may be suppressed.

In addition, according to an embodiment of the disclosure, the photocatalyst material may exhibit a catalytic activity across a UV-A and visible wavelength range.

Another embodiment of the disclosure provides a method for synthesizing a highly efficient photocatalyst material for decomposing organic hazardous substances.

The method for synthesizing a highly efficient photocatalyst material for decomposing organic hazardous substances according to an embodiment of the disclosure may include: forming a bio-silica solution by dispersing bio-silica in a solvent; adding an aqueous solution including a Ti³⁺ precursor to the formed bio-silica solution to form a mixed solution; and performing a low-temperature atmospheric pressure plasma process which is applying low-temperature atmospheric pressure air plasma to the formed mixed solution.

In addition, according to an embodiment of the disclosure, the forming of the bio-silica solution may disperse the bio-silica in a solvent through an ultrasonic disperser.

In addition, according to an embodiment of the disclosure, the forming of the mixed solution may make a mass ratio of the Ti³⁺ precursor to the bio-silica be 0.02 wt % to 20 wt %.

In addition, according to an embodiment of the disclosure, in the forming of the mixed solution, an added TiCl3 aqueous solution may have a concentration of 10% to 15%.

In addition, according to an embodiment of the disclosure, the performing of the low-temperature atmospheric pressure plasma process may be performed for 10 minutes or less.

In addition, according to an embodiment of the disclosure, the performing of the low-temperature atmospheric pressure plasma process may be performing a reaction to simultaneously synthesize a TiO₂ quantum dot and a TiO₂₋ₓ quantum dot from a TiCl₃ substance, and the X is a real number greater than 0 and less than 2.

In addition, according to an embodiment of the disclosure, the performing of the low-temperature atmospheric pressure plasma process may make, in the entire synthesized photocatalyst material, a ratio of the presence of the TiO₂ quantum dot and TiO₂₋ₓ quantum dot be 2:8 to 8:2.

According to an embodiment of the disclosure, it is possible to provide a highly efficient photocatalyst material for decomposing organic hazardous substances and a method for synthesizing the same, by utilizing silica or diatomaceous earth having micropores that cannot be used in semiconductor processes through a low-temperature atmospheric pressure plasma synthesis method, thereby exhibiting high-efficiency photocatalytic performance under a wide range of light sources such as low-light, visible light, and UV-A.

According to an embodiment of the disclosure, it is possible to provide a highly efficient photocatalyst material for decomposing organic hazardous substances and a method for synthesizing the same, which have excellent efficacy in decomposing and removing methylene blue (MB), a representative dyeing pollutant, and tetramethylammonium hydroxide (TMAH), an organic substance from semiconductor wastewater that is difficult to treat.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view showing synthesis steps of a highly efficient photocatalyst material for decomposing organic hazardous substances according to an embodiment of the disclosure;

FIG. 2 is a schematic view showing a reaction progress of a method for synthesizing a highly efficient photocatalyst material for decomposing organic hazardous substances according to an embodiment of the disclosure;

FIG. 3 is a photograph showing a photocatalytic test of a highly efficient photocatalyst material for decomposing organic hazardous substances according to an embodiment of the disclosure;

FIG. 4 is a graph showing the results of an XRD analysis of a highly efficient photocatalyst material for decomposing organic hazardous substances according to an embodiment of the disclosure;

FIG. 5A is a graph showing the results of an XPS analysis in the binding energy range of 452-470 eV for a highly efficient photocatalyst material for decomposing organic hazardous substances according to an embodiment of the disclosure;

FIG. 5B is a graph showing the results of an XPS analysis in the binding energy range of 526-536 eV for a highly efficient photocatalyst material for decomposing organic hazardous substances according to an embodiment of the disclosure;

FIG. 6 is a graph showing the results of an FTIR analysis of a highly efficient photocatalyst material for decomposing organic hazardous substances according to an embodiment of the disclosure;

FIGS. 7A and 7B are each a transmission electron microscope analysis image of a highly efficient photocatalyst material for decomposing organic hazardous substances according to an embodiment of the disclosure;

FIGS. 8A and 8B are electron microscope and EDS analysis images of a highly efficient photocatalyst material for decomposing organic hazardous substances according to an embodiment of the disclosure;

FIGS. 9A and 9B are each a graph showing surface area and pore size distribution of a highly efficient photocatalyst material for decomposing organic hazardous substances according to an embodiment of the disclosure;

FIGS. 10A and 10B are each a graph showing UV-Vis light absorption measurement results of a highly efficient photocatalyst material for decomposing organic hazardous substances according to an embodiment of the disclosure;

FIG. 11 is a graph showing the decomposition rate of organic hazardous substances according to lighting conditions at high concentrations of a highly efficient photocatalyst material for decomposing organic hazardous substances according to an embodiment of the disclosure;

FIG. 12 is a graph showing a decomposition rate of organic hazardous substances according to illumination conditions at an ultra-high concentration of a highly efficient photocatalyst material for decomposing organic hazardous substances according to an embodiment of the disclosure;

FIG. 13 is an actual photograph showing a decomposition ability of a dyed organic substance according to an embodiment of the disclosure over time of a highly efficient photocatalyst material for decomposing organic hazardous substances;

FIGS. 14A and 14B are each data showing a decomposition ability of organic hazardous substances generated in a semiconductor process of a highly efficient photocatalyst material for decomposing organic hazardous substances according to an embodiment of the disclosure;

FIGS. 15A and 15B are each a graph showing a decomposition ability when a highly efficient photocatalyst material for decomposing organic hazardous substances according to an embodiment of the disclosure is repeatedly used for decomposing dyed organic substances; and

FIGS. 16A and 16B are each a graph showing a decomposition ability when a highly efficient photocatalyst material for decomposing organic hazardous substances according to an embodiment of the disclosure is repeatedly used for decomposing organic pollutants generated in a semiconductor process.

### DETAILED DESCRIPTION

Hereinafter, the disclosure will be described with reference to the accompanying drawings. However, the disclosure may be implemented in various different forms, and therefore is not limited to the embodiments described herein, and should be understood as including all modifications, equivalents, or substitutes included in the spirit and technical scope of the disclosure.

In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between.

In addition, when a part such as a layer, film, region, or plate is said to be “above” another part, this includes not only the case where it is “directly above” another part, but also the case where there is another part in between. In addition, in this specification, when a part such as a layer, film, region, or plate is formed on another part, the direction in which it is formed is not limited to the upper direction, and includes being formed in the side or lower direction. On the contrary, when a part such as a layer, film, region, or plate is said to be “under” another part, this includes not only the case where it is “directly under” another part, but also the case where there is another part in between.

In this specification, the terms “upper surface” and “lower surface” are used as relative concepts in order to easily explain the technical idea of the disclosure. Therefore, the terms “upper surface” and “lower surface” do not refer to a specific direction, position, or component, and are interchangeable with each other.

For example, the “upper surface” may be interpreted as the “lower surface,” and the “lower surface” may be interpreted as the “upper surface.” Therefore, the “upper surface” may be expressed as “first” and the “lower surface” may be expressed as “second”, or the “lower surface” may be expressed as “first” and the “upper surface” may be expressed as “second”. However, within one embodiment, the terms “upper surface” and “lower surface” are not used interchangeably.

Unless otherwise defined, all terms used herein, including technical or scientific terms, have the same meaning as generally understood by a person of ordinary skill in the art to which the disclosure belongs. Terms defined in commonly used dictionaries should be interpreted as having a meaning consistent with the meaning they have in the context of the relevant technology, and shall not be interpreted in an ideal or overly formal sense unless explicitly defined in this application.

In addition, when a part is said to “include” a certain component, this does not mean that other components are excluded unless otherwise specifically stated, but that other components may be additionally provided.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

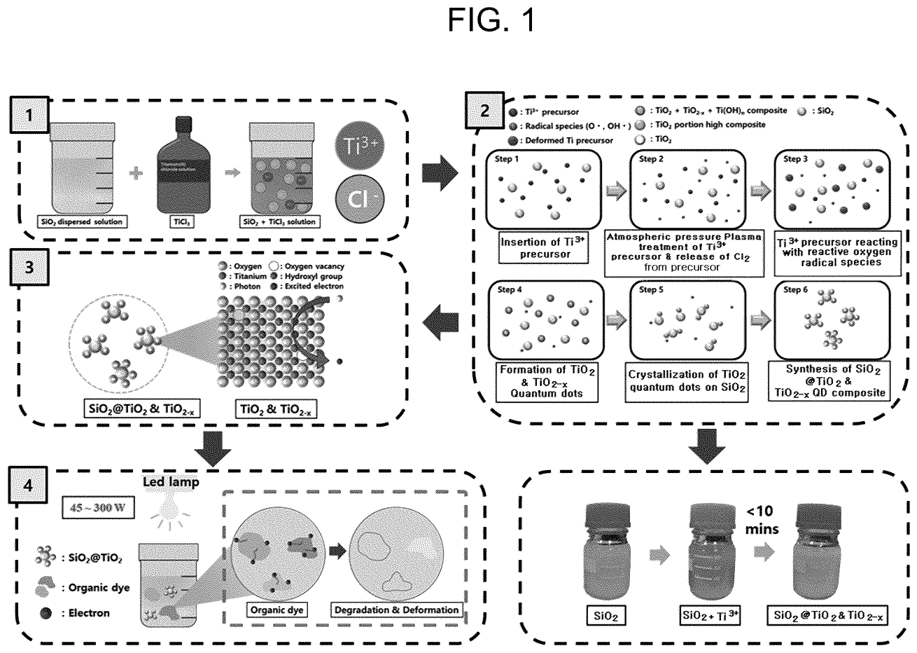

FIG. 1 is a schematic view showing synthesis steps of a highly efficient photocatalyst material for decomposing organic hazardous substances according to an embodiment of the disclosure.

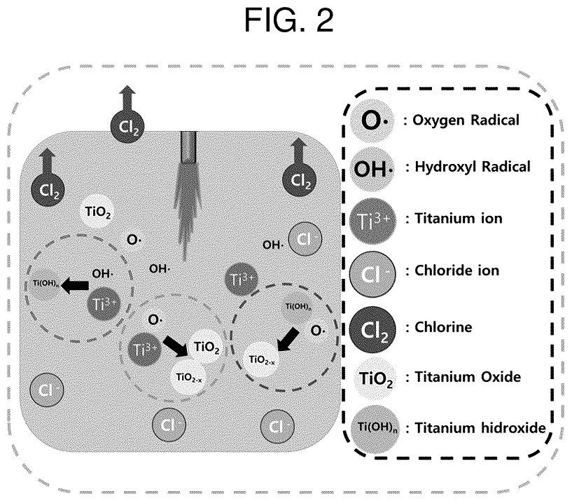

FIG. 2 is a schematic view showing a reaction progress of a method for synthesizing a highly efficient photocatalyst material for decomposing organic hazardous substances according to an embodiment of the disclosure.

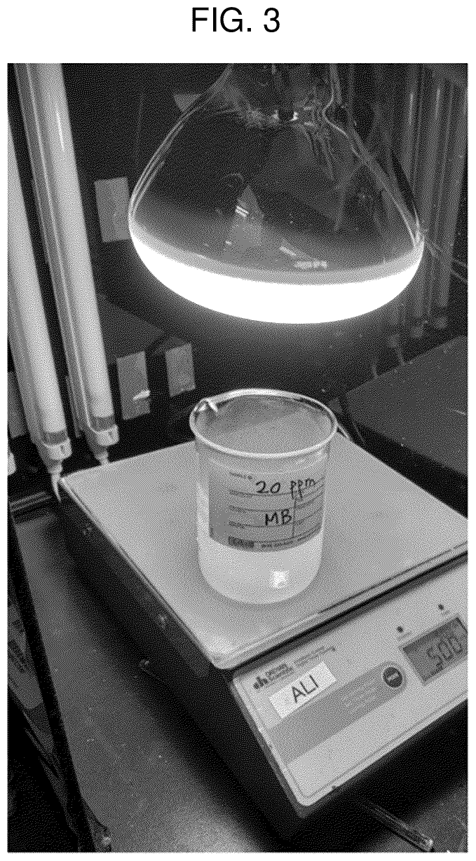

FIG. 3 is a photograph showing a photocatalytic test of a highly efficient photocatalyst material for decomposing organic hazardous substances according to an embodiment of the disclosure.

Referring to FIGS. 1 to 3, a highly efficient photocatalyst material for decomposing organic hazardous substances according to an embodiment of the disclosure will be described.

As an example of the above embodiment, there may be a highly efficient photocatalyst material for decomposing organic hazardous substances, the material including: silica having micropores formed; and a quantum dot substance surrounding the silica, wherein the quantum dot substance is coexistence of a TiO₂ quantum dot and a TiO₂₋ₓ quantum dot, and the X is a real number greater than 0 and less than 2.

In the case of the above embodiment, silica or diatomaceous earth having micropores that cannot be used in a semiconductor process was utilized through a low-temperature atmospheric pressure plasma synthesis method, and a TiO₂ quantum dot exhibiting high-efficiency photocatalytic performance under a wide range of light sources such as low-light, visible light, and UV-A was synthesized in a short period of time (within 10 minutes), thereby providing a highly efficient photocatalyst material for decomposing organic hazardous substances.

In particular, this may have a multi-crystal structure including both rutile crystals and anatase crystals, and a stable and highly efficient photocatalyst material was developed by combining quantum dots containing oxygen defects and OH functional groups that activate photocatalytic activity in visible light with silica particles.

The highly efficient photocatalyst material for decomposing organic hazardous substances according to the above embodiment showed excellent efficacy in decomposing and removing representative dyeing pollutant substance methylene blue (MB) and organic substance tetramethylammonium hydroxide (TMAH) from semiconductor wastewater that is difficult to treat, and has excellent efficacy in decomposing the above substances in a short time even under low-intensity light sources or visible light.

The developed material and technology is applicable to various environmental fields because they have excellent efficacy in decomposing organic hazardous substances such as water treatment filters and air purification filters.

Referring to FIGS. 1 and 2, the structure of the highly efficient photocatalyst material for decomposing organic hazardous substances can be more intuitively understood, wherein referring to No. 3 picture of FIG. 1, silica and titanium oxide surrounding the silica may be confirmed, micropores are formed in the silica, and when the titanium oxide is enlarged, it may be confirmed that some oxygen defects occur in TiO₂ and thus the structure is one in which the TiO₂ and TiO₂₋ₓ coexist.

The X means the amount of oxygen in which a defect occurs, and as described above, the X may be a real number greater than 0 and less than 2.

As in the above embodiment, when a TiO₂ quantum dot (UV light activation) and a TiO₂₋ₓ quantum dot (visible light activation) coexist as quantum dot substances, there is an excellent effect in that catalytic activation is possible even under UV light and visible light.

As an example of the above embodiment, there may be a highly efficient photocatalyst material for decomposing organic hazardous substances, characterized in that a porosity of the nanopores formed in the silica is 2 nm to 100 nm.

The porosity of the nanopores will be described in more detail through the following experimental examples.

As an example of the above embodiment, there may be a highly efficient photocatalyst material for decomposing organic hazardous substances, characterized in that a diameter of the nanopores formed in the silica is of 8 nm to 100 nm.

As an example of the above embodiment, there may be a highly efficient photocatalyst material for decomposing organic hazardous substances, characterized in that a TiO2−x quantum dot include an oxygen defect or a hydroxyl group (—OH).

Referring to No. 3 picture of FIG. 1, when seeing an enlarged part of the TiO₂ & TiO₂₋ₓ, it may be confirmed that there are cases where the Oxygen vacancy or Hydroxyl group is positioned in a place where the Oxygen should be.

As above, in the case where the Oxygen vacancy or Hydroxyl group is positioned in a place where the Oxygen should be, an excellent effect can be obtained in that the catalyst activation is possible not only in a UV region where the light source band can absorb light, but also in a visible light region, which is a low-energy light source.

By including a TiO₂₋ₓ quantum dot having an oxygen defect or OH functional group, it is possible to have the advantage of being able to activate the photocatalyst even under visible light.

In the case of a TiO₂₋ₓ structure having an oxygen defect or OH functional group, there is the effect of reducing a band gap of the TiO₂ and enables the catalyst activation under visible light.

As an example of the above embodiment, there may be a highly efficient photocatalyst material for decomposing organic hazardous substances, characterized by having a multi-crystal structure including a rutile crystal structure and an anatase crystal structure.

As described above, when a TiO₂ quantum dot has a multi-crystal structure including both a rutile crystal structure and an anatase crystal structure rather than a single crystal, an excellent effect can be obtained in that the electron-hole separation can be improved more than when it is a single anatase or rutile crystal, and thus the catalyst can be activated more effectively.

As an example of the above embodiment, there may be a highly efficient photocatalyst material for decomposing organic hazardous substances, characterized by having a ratio of the TiO₂ quantum dot and the TiO₂₋ₓ quantum dot in the entire photocatalyst material of 2:8 to 8:2.

As an example of the above embodiment, there may be a highly efficient photocatalyst material for decomposing organic hazardous substances, characterized in that the reduction of a defective TiO₂₋ₓ quantum dot to a TiO₂ quantum dot in an oxygen-containing environment is suppressed through a Ti—O—Si bond formed by bonding of silica and a TiO₂₋ₓ quantum dots surrounding the silica. TiO2−x.

As an example of the above embodiment, the photocatalyst material may be a highly efficient photocatalyst material for decomposing organic hazardous substances, characterized by exhibiting a catalytic activity in an entire UV-A and visible light wavelength range.

Referring to No. 4 picture of FIG. 1, a schematic view showing that organic pollutants are rapidly decomposed in an LED, fluorescent lamp, or low-intensity solar lamp may be confirmed.

The UV-A (ultraviolet-A) refers to ultraviolet rays having a wavelength range of 315 nm to 400 nm.

The visible light has a wavelength range of 380 nm to 780 nm.

That is, the photocatalyst material is characterized by exhibiting a catalytic activity in an entire wavelength range of 315 nm to 780 nm.

A TiO₂ material, a representative photocatalyst material that has been widely studied and researched, is a photocatalyst material that requires high energy usage to decompose hazardous substances or organic substances through photocatalytic activation under a high-energy light source, a UV light source.

In the case of the above embodiment, there is an advantage in that it has photoactivity in a wavelength range that covers a very wide wavelength range including not only the UV light source but also the wavelength range of visible light.

A method for synthesizing a highly efficient photocatalyst material for decomposing organic hazardous substances according to another embodiment of the disclosure will be described.

As an example of the above embodiment, there may be a method for synthesizing a highly efficient photocatalyst material for decomposing organic hazardous substances, the method including: forming a bio-silica solution by dispersing bio-silica in a solvent; adding an aqueous solution including a Ti³⁺ precursor to the formed bio-silica solution to form a mixed solution; and performing a low-temperature atmospheric pressure plasma process which is applying low-temperature atmospheric pressure air plasma to the formed mixed solution.

Referring to No. 1 picture of FIG. 1, the above-described synthesis process may be intuitively confirmed.

First, bio-silica is dispersed in a solvent to form a bio-silica solution, and then an aqueous solution containing a Ti³⁺ precursor is added to the formed bio-silica solution to form a mixed solution.

At this time, a TiCl₃ aqueous solution may be used as the aqueous solution containing a Ti³ precursor, wherein when the TiCl₃ aqueous solution is added to the silica solution, the TiCl₃ substance is ionized into Ti³⁺ and Cl⁻, thereby ultimately providing Ti³⁺.

Referring to No. 2 picture of FIG. 1, it may be confirmed that the Ti³⁺ substance is added in Step 1 through the same method as No. 1 picture of FIG. 1, and that plasma treatment at atmospheric pressure is performed in Step 2.

Afterwards, in Step 3, the Ti³⁺ substance reacts with an oxygen radical substance to generate a deformed Ti substance;
in Step 4, TiO2 & TiO2−x quantum dots are synthesized;
in Step 5, the synthesized titanium oxide substance is crystallized on the silica substance; and
in Step 6, a highly efficient photocatalyst material (SiO₂@TiO₂ & TiO₂₋ₓ QD complex) for decomposing organic hazardous substances corresponding to the above embodiment is finally synthesized.

As an example of the above embodiment, there may be a method for synthesizing a highly efficient photocatalyst material for decomposing organic hazardous substances, characterized in that the forming of the bio-silica solution disperses the bio-silica in a solvent through an ultrasonic disperser.

As an example of the above embodiment, there may be a method for synthesizing a highly efficient photocatalyst material for decomposing organic hazardous substances, characterized in that the forming of the mixed solution makes a mass ratio of the TiCl₃ precursor to the bio-silica be 0.02 wt % to 20 wt %.

When the mass ratio of the TiCl₃ to the bio-silica is less than 0.02 wt %, there is a problem that the amount of synthesized TiO₂ is very small, and on the contrary, when the mass ratio of the TiCl₃ to the bio-silica is 20 wt % or more, there are problems that the synthesis speed is slowed down, making it difficult to synthesize at a fast speed, and that a large amount of samples that are not completely synthesized may be produced during a cleaning process.

As an example of the above embodiment, there may be a method for synthesizing a highly efficient photocatalyst material for decomposing organic hazardous substances, characterized in that in the forming of the mixed solution, an added TiCl₃ aqueous solution has a concentration of 10% to 15%.

As an example of the above embodiment, there may be a method for synthesizing a highly efficient photocatalyst material for decomposing organic hazardous substances, characterized in that the performing of the low-temperature atmospheric pressure plasma process is performed for 10 minutes or less.

As described above, in the case of the above embodiment, a desired quantum dot may be synthesized very quickly through a plasma process performed for less than 10 minutes.

As an example of the above embodiment, there may be a method for synthesizing a highly efficient photocatalyst material for decomposing organic hazardous substances, characterized in that the performing of the low-temperature atmospheric pressure plasma process is performing a reaction to simultaneously synthesize a TiO₂ quantum dot and a TiO₂₋ₓ quantum dot from a TiCl₃ substance, and the X is a real number greater than 0 and less than 2.

Through No. 2 picture of FIG. 1, the reaction of simultaneously synthesizing the TiO₂ quantum dot and TiO_{2 x} quantum dot may be confirmed through a schematic diagram.

As an example of the above embodiment, there may be a method for synthesizing a highly efficient photocatalyst material for decomposing organic hazardous substances, characterized in that the performing of the low-temperature atmospheric pressure plasma process makes, in the entire synthesized photocatalyst material, a ratio of the presence of the TiO₂ quantum dot and TiO₂₋ₓ quantum dot be 2:8 to 8:2.

More preferably, as an example of the above embodiment, there may be a method for synthesizing a highly efficient photocatalyst material for decomposing organic hazardous substances, characterized in that the performing of the low-temperature atmospheric pressure plasma process makes, in the entire synthesized photocatalyst material, a ratio of the presence of the TiO₂ quantum dot and TiO₂₋ₓ quantum dot be 4:6 to 6:4.

If a ratio of the TiO₂ quantum dot and TiO₂₋ₓ quantum dot exists is lower than 8:2, a problem occurs in which a catalytic activity does not sufficiently occur under visible light, and
on the contrary, if a ratio of the TiO₂ quantum dot and TiO₂₋ₓ quantum dot exists is higher than 2:8, a problem occurs in which a catalytic activity does not sufficiently occur under UV-A.

### Production Example 1. Highly Efficient Photocatalyst Material (SiO₂@TiO₂ & TiO₂₋ₓ QD complex) for Decomposing Organic Hazardous Substances According to an Embodiment of the Disclosure

1. 0.5 g of bio-silica is dispersed in water for 20 minutes using a bath sonicator.
2.3 ml of TiCl₃ solution (10-15% TiCl₃ aqueous solution) for TiO₂ quantum dot synthesis is added to the bio-silica solution (mud color) dispersed in water, and then shaken well again to disperse.
3. The bio-silica solution (purple) to which the TiCl₃ solution was added was subjected to low temperature, atmospheric pressure, and air plasma for 8 minutes and 30 seconds.
4. After applying the plasma, the solution turned white, indicating that the synthesis was complete.

### Experimental Example 1. Experimental Process for Decomposing Organic Pollutant Substances

1. A TiO₂ & TiO₂₋ₓ quantum dot-combined diatomaceous earth solution synthesized through production example 1 above is cleaned in DI water and then collected through vacuum filtration to collect powders.
2. The collected powders are dried for about half a day and then collected.
3. 50 mg of TiO₂ & TiO₂₋ₓ quantum dot-combined diatomaceous earth is added to a solution containing organic contaminants (100 mL) and mixed well while shining light from an LED, solar lamp, or fluorescent light source at a distance of 10 cm.
4. Through the above steps, the organic contaminant substance is decomposed and removed.
5. For high-concentration contaminant substance solutions, a 20 ppm solution (20 mg/L) is used, and for ultra-high-concentration removal experiments, a 100 ppm solution (100 mg/L) is used.
6. For the tested example contaminant substances, the contaminant substance decomposition ability is tested through Methylene blue organic substances (dyeing organic contaminant substance) and TMAH (organic contaminant substance frequently used in semiconductor processes).
7. In addition, the contaminant substance removal rate is measured using UV-Vis absorption measuring equipment and TOC equipment for a solution containing contaminant substances at 30-minute intervals.

Referring to FIG. 3, it is possible to confirm an actual photo of a device under photocatalytic testing.

### Experimental Example 2. Structural Analysis of SiO₂@TiO₂ & TiO₂₋ₓ QD Complex

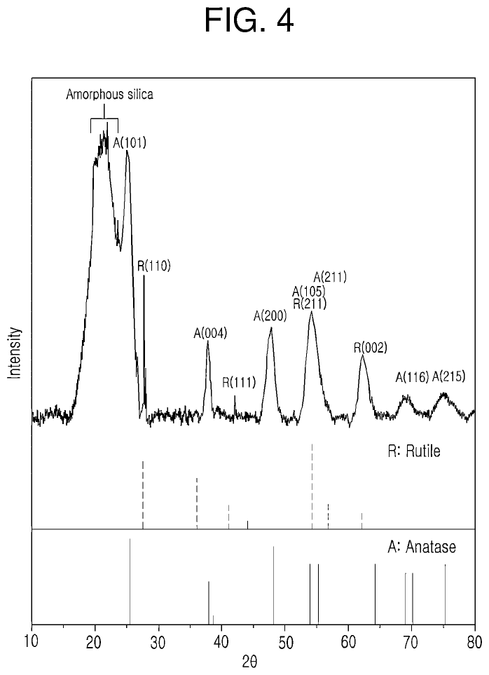

FIG. 4 is a graph showing the results of an XRD analysis of a highly efficient photocatalyst material for decomposing organic hazardous substances according to an embodiment of the disclosure.

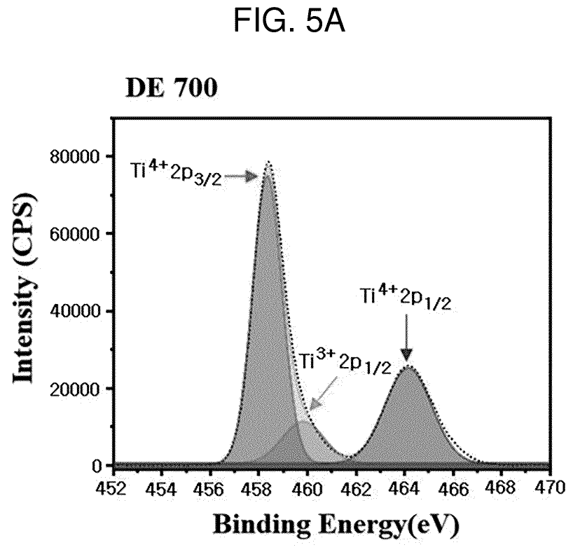

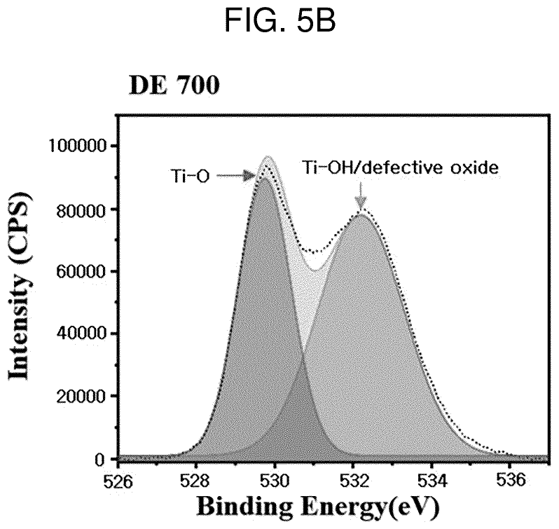

FIG. 5A is a graph showing the results of an XPS analysis in the binding energy range of 452-470 e V for a highly efficient photocatalyst material for decomposing organic hazardous substances according to an embodiment of the disclosure.

FIG. 5B is a graph showing the results of an XPS analysis in the binding energy range of 526-536 eV for a highly efficient photocatalyst material for decomposing organic hazardous substances according to an embodiment of the disclosure.

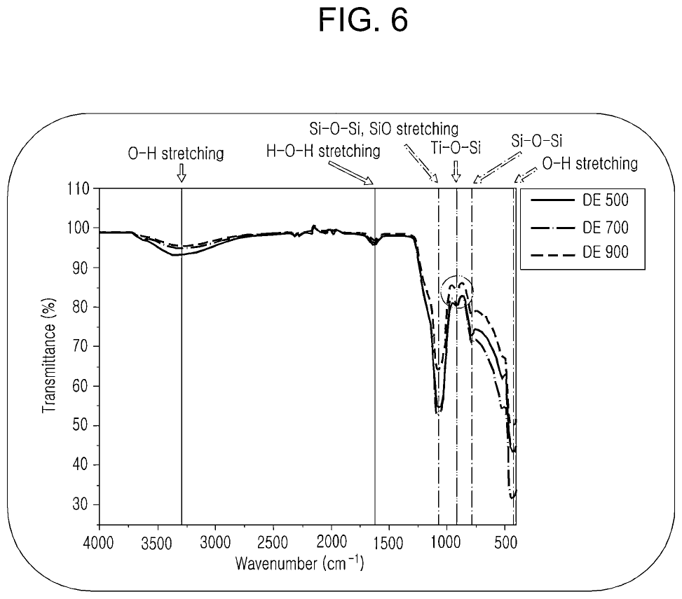

FIG. 6 is a graph showing the results of an FTIR analysis of a highly efficient photocatalyst material for decomposing organic hazardous substances according to an embodiment of the disclosure.

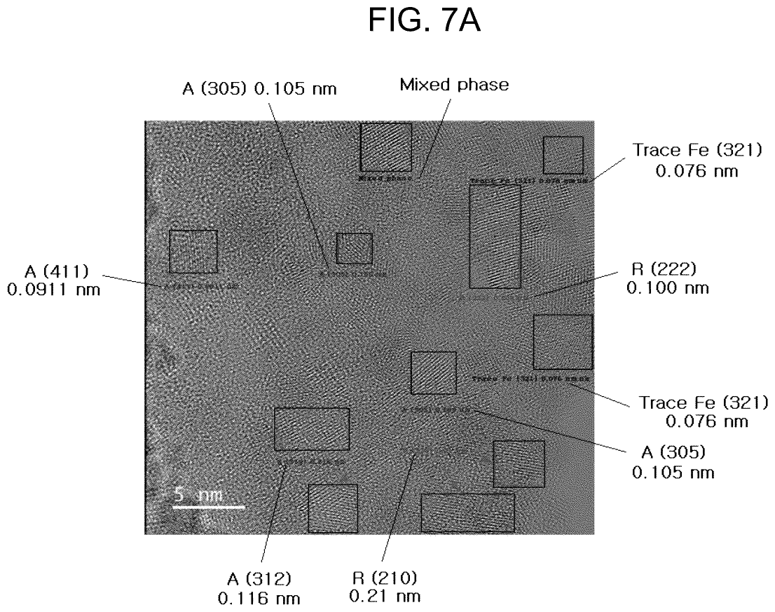

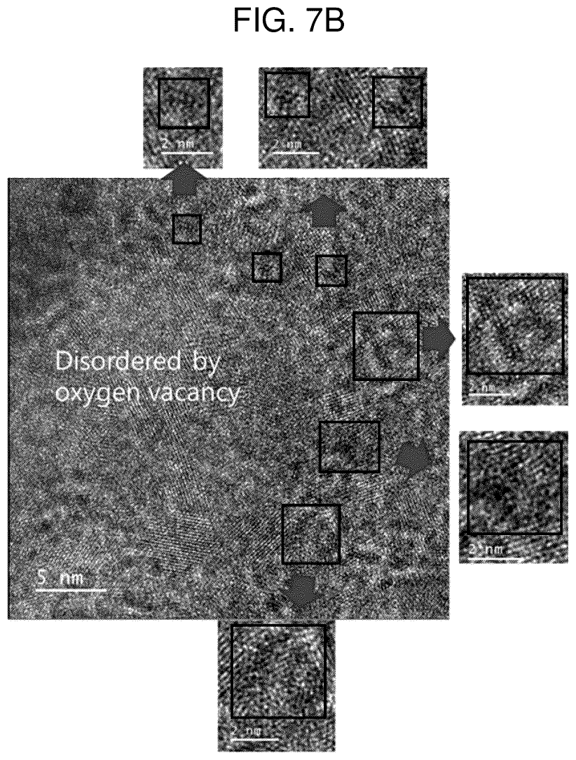

FIGS. 7A and 7B are each a transmission electron microscope analysis image of a highly efficient photocatalyst material for decomposing organic hazardous substances according to an embodiment of the disclosure.

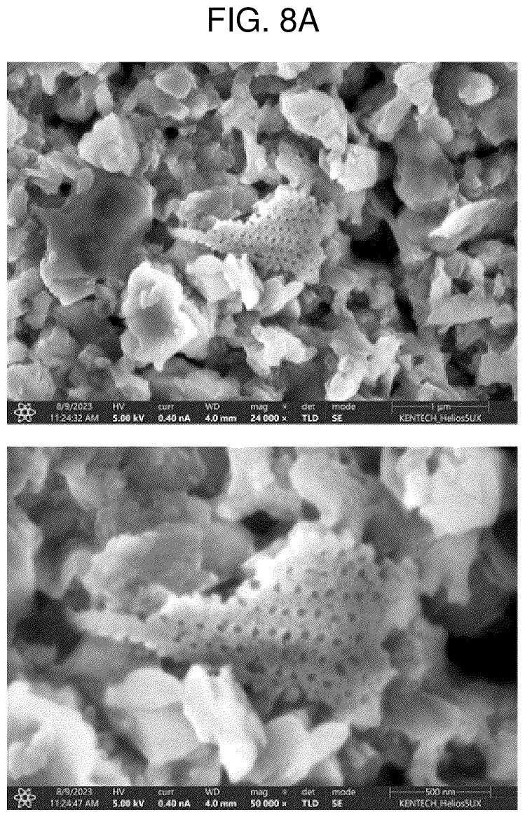

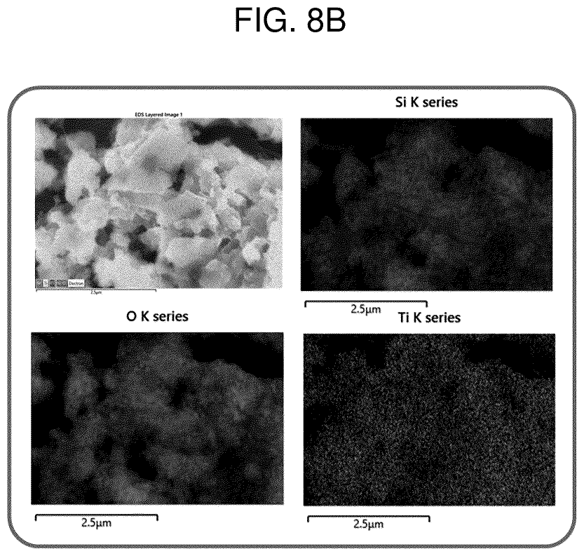

FIGS. 8A and 8B are electron microscope and EDS analysis images of a highly efficient photocatalyst material for decomposing organic hazardous substances according to an embodiment of the disclosure.

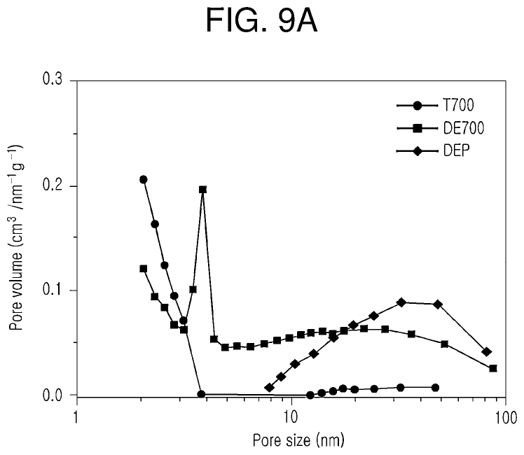

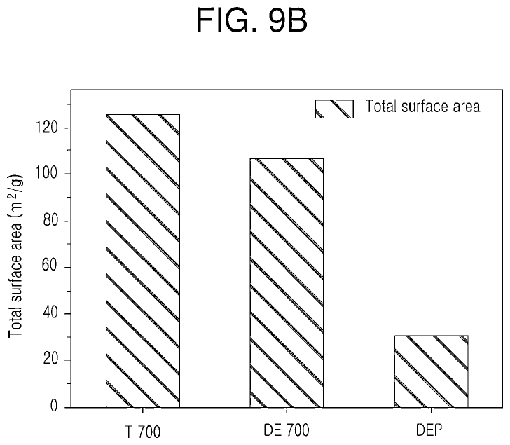

FIGS. 9A and 9B are each a graph showing surface area and pore size distribution of a highly efficient photocatalyst material for decomposing organic hazardous substances according to an embodiment of the disclosure.

Experimental example 2 will be described with reference to FIGS. 4 to FIGS. 9A and 9B.

In FIG. 4, a crystal structure of a bio-silica-TiO₂ catalyst material synthesized through an atmospheric pressure low temperature plasma process may be compared with crystal structures of anatase and rutile through the XRD analysis results, and referring to FIG. 4, it may be confirmed that the bbio-silica-TiO₂ catalyst material synthesized through the atmospheric pressure low temperature plasma process according to an embodiment of the disclosure has a structure that includes both crystal structures of anatase and rutile.

Referring to FIGS. 5A and 5B, it may be confirmed through the XPS analysis results that a bio-silica-TiO₂ catalyst material synthesized through an atmospheric pressure low temperature plasma process according to an embodiment of the disclosure contains oxygen defects.

That is, it may be confirmed that a TiO₂₋ₓ structure and a TiO₂ structure coexist.

Referring to FIG. 6, through the FTIR analysis results, it may be confirmed that a bio-silica-TiO₂ catalyst material synthesized through an atmospheric pressure low-temperature plasma process according to an embodiment of the disclosure has OH functional group defects and that diatomaceous earth and TiO₂ & TiO₂₋ₓ quantum dots may can stably through the Ti—O—Si bond.

Through FIG. 6, it may be confirmed that TiO₂₋ₓ quantum dots maintain their structure through more stable chemical bonding (Chemisorption) rather than physical bonding (Physisorption), and through this, it may be confirmed that the advantage of long-term long-cycle catalyst activation is possible under visible light by preventing the defects of TiO₂ from being filled in an environment with a lot of oxygen and moisture.

Referring to FIG. 7A, it may be confirmed through transmission electron microscope analysis images that a bio-silica-TiO₂ catalyst material synthesized through an atmospheric pressure low-temperature plasma process according to an embodiment of the disclosure has a diameter of 2 nm to 5 nm and that the catalyst material includes both crystal planes of anatase and rutile, and Referring to FIG. 7B, it may be confirmed through transmission electron microscope analysis images that a bio-silica-TiO₂ catalyst material synthesized through an atmospheric pressure low-temperature plasma process according to an embodiment of the disclosure has oxygen defects.

Referring to FIGS. 8A and 8B, it may be confirmed through electron microscope and EDS analysis images that a bio-silica-TiO2 catalyst material synthesized through an atmospheric pressure low-temperature plasma process according to an embodiment of the disclosure has nanopores and is composed of Si, Ti, and O elements.

In FIGS. 9A and 9B, the porosity and surface area of pores formed on the surface of T700, DE700, and DEP may be confirmed, and referring to FIG. 9A, in the case of bio-silica (DEP), the diameter of pores formed on the surface is 8 nm to 100 nm, and the volume of pores corresponding to each diameter is 0.1 cm³nm⁻¹g⁻¹ or less.

In addition, in the case of TiO₂ bio-silica (DE 700) developed by plasma synthesis, the diameter of pores formed on the surface is 2 nm to 100 nm, and the volume of the pores corresponding to each diameter is 0.4 cm³nm⁻¹g⁻¹ or more. In particular, it may be confirmed that pores with the diameter of 0.2 cm³nm⁻¹g⁻¹ or more and 0.4 cm³nm⁻¹g⁻¹ or less occupy the largest proportion of 0.2 cm³nm⁻¹g⁻¹ or more.

In addition, in the case of TiO₂(T 700) developed by a plasma synthesis method, it may be confirmed that the diameter of pores formed on the surface is 2 nm or more and less than 4 nm, and the volume of the pores corresponding to each diameter is formed to be 0.2 cm³nm⁻¹g⁻¹ or less.

Referring to FIG. 9B, it may be confirmed that the TiO₂ & TiO₂₋ₓ (T 70)0 has the largest total surface area with a total surface area of about 120 m²/g, followed by TiO₂ & TiO₂₋ₓ-bio-silica (DE 700) with a total surface area of about 105 m²/g, and the bio-silica has the smallest surface area with a total surface area of about 25 m²/g.

Through FIG. 9A, it may be confirmed that in the case of TiO₂ & TiO₂₋ₓ, pores corresponding to 2-3 nm constitute the majority, and in the case of extremely small pores as mentioned above, there is a problem that it is difficult to adsorb large organic substances to a catalyst material before they are sufficiently decomposed.

On the contrary, in the case of TiO₂ & TiO₂₋ₓ bio-silica composites, it may be confirmed that pores corresponding to about 3-5 nm constitute the majority.

In particular, pores corresponding to 3˜5 nm have the advantage of easily adsorbing organic substances with particle sizes of 2 nm or more, and can have the effect of effectively binding organic substances to the catalyst material until the organic particles undergo a decomposition process and are mineralized (converted to CO2+H2O in the organic substance) after adsorption.

### Experimental Example 3. Performance Analysis of SiO₂@TiO₂ & TiO_{2 x} QD Complex

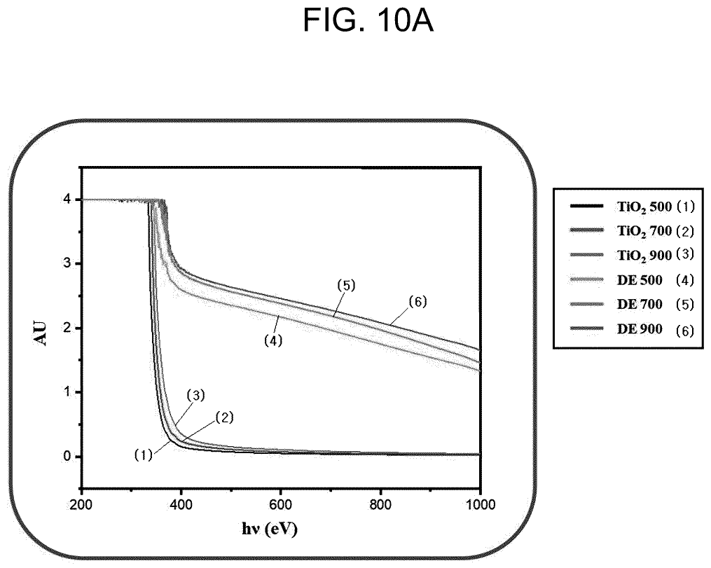

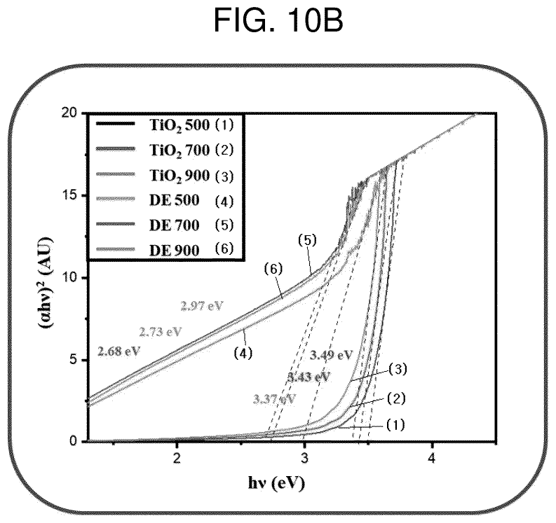

FIGS. 10A and 10B are each a graph showing UV-Vis light absorption measurement results of a highly efficient photocatalyst material for decomposing organic hazardous substances according to an embodiment of the disclosure.

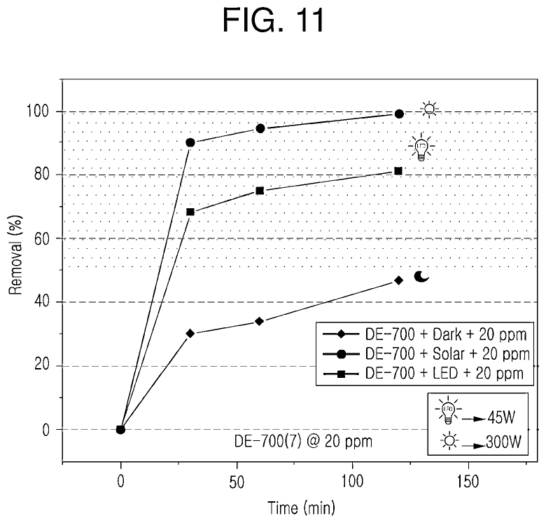

FIG. 11 is a graph showing the decomposition rate of organic hazardous substances according to lighting conditions at high concentrations of a highly efficient photocatalyst material for decomposing organic hazardous substances according to an embodiment of the disclosure.

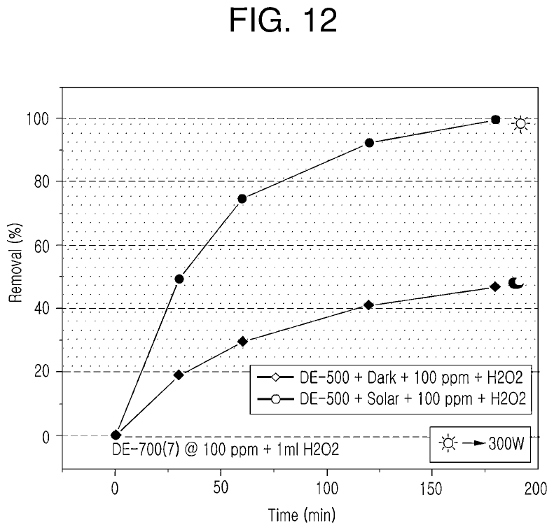

FIG. 12 is a graph showing a decomposition rate of organic hazardous substances according to illumination conditions at an ultra-high concentration of a highly efficient photocatalyst material for decomposing organic hazardous substances according to an embodiment of the disclosure.

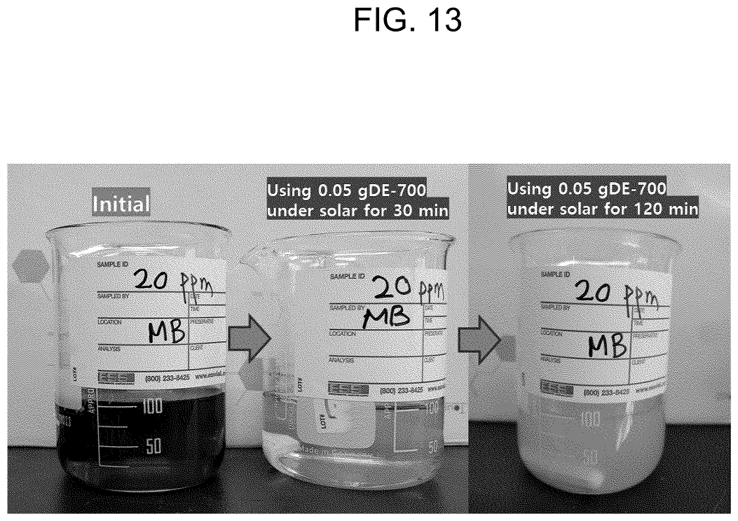

FIG. 13 is an actual photograph showing a decomposition ability of a dyed organic substance according to an embodiment of the disclosure over time of a highly efficient photocatalyst material for decomposing organic hazardous substances.

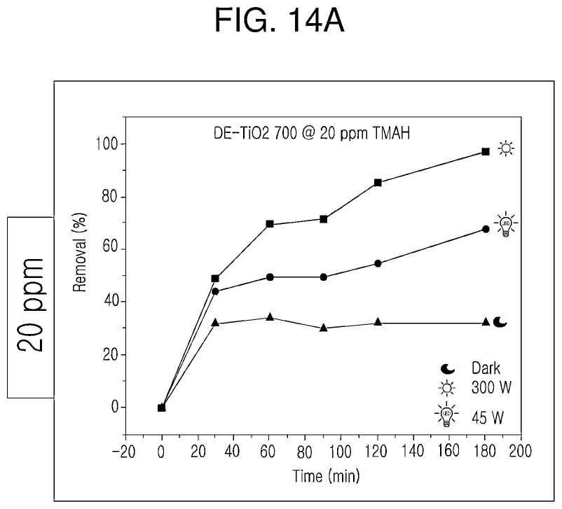

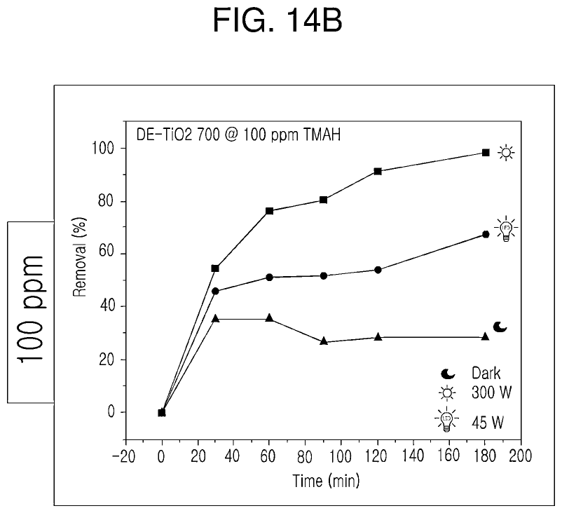

FIGS. 14A and 14B are each data showing a decomposition ability of organic hazardous substances generated in a semiconductor process of a highly efficient photocatalyst material for decomposing organic hazardous substances according to an embodiment of the disclosure.

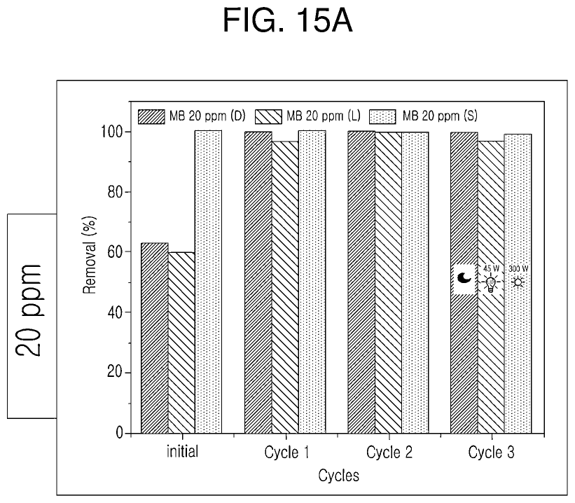

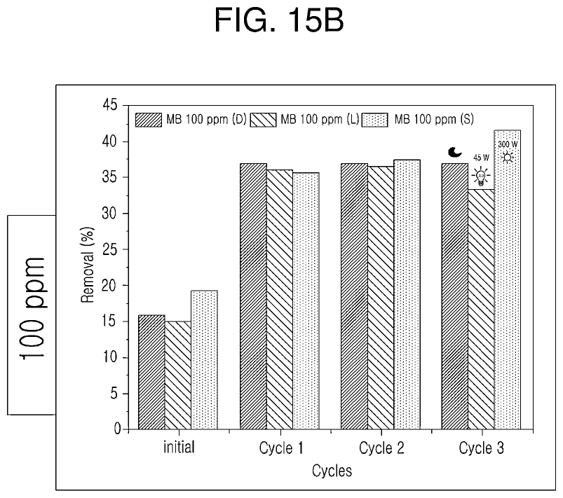

FIGS. 15A and 15B are each a graph showing a decomposition ability when a highly efficient photocatalyst material for decomposing organic hazardous substances according to an embodiment of the disclosure is repeatedly used for decomposing dyed organic substances.

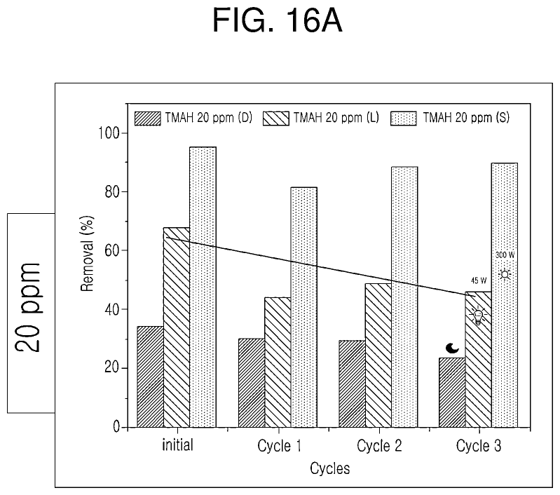

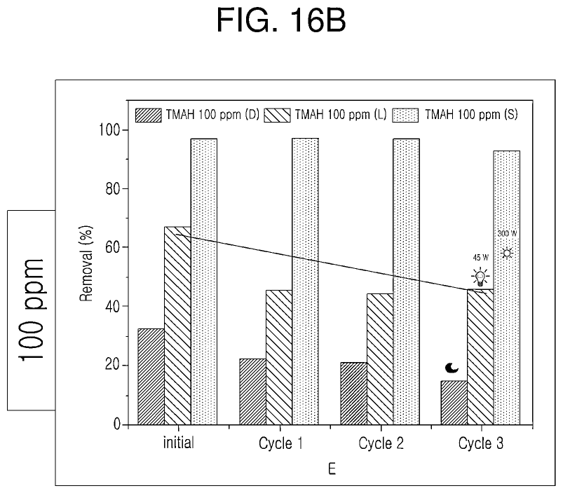

FIGS. 16A and 16B are each a graph showing a decomposition ability when a highly efficient photocatalyst material for decomposing organic hazardous substances according to an embodiment of the disclosure is repeatedly used for decomposing organic pollutants generated in a semiconductor process.

Experimental example 3 will be described with reference to FIGS. 10A and 10B to FIGS. 16A and 16B.

Referring to FIGS. 10A and 10B, the UV-Vis light absorption measurement results show that a bio-silica-TiO₂ catalyst material synthesized through an atmospheric pressure low-temperature plasma process according to an embodiment of the disclosure exhibits light absorption in a wide light source band covering an entire UV-A and visible wavelength range,
and among them, a DE 700 sample exhibits the lowest band gap.

This means that the SiO₂@TiO₂ & TiO₂₋ₓ QD complex is capable of absorbing light not only in the UV-A wavelength but also in the visible light region.

At this time, the DE-700 is a TiO2-bio-silica sample synthesized by applying plasma power at 700 watts, and the DE-500 means a TiO2-bio-silica sample synthesized by applying plasma power at 500 watts.

In FIG. 11, organic substance removal efficiency is measured by using 20 mg/L of a high-concentration contaminant substance solution (20 ppm solution).

Referring to FIG. 11, it may be confirmed that thea bio-silica-TiO₂ catalyst material synthesized through an atmospheric pressure low-temperature plasma process according to an embodiment of the disclosure has a high organic substance (dyeing organic substance MB) decomposition rate of about 80% or more even under a low-intensity LED light source, and it may be confirmed that an organic substance (dyeing organic substance MB) removal rate close to 100% is shown under a low-intensity solar lamp or incandescent lamp.

In FIG. 12, organic substance removal efficiency is measured using 100 mg/L of an ultra-high concentration contaminant substance solution (100 ppm solution).

Referring to FIG. 12, when a mixture of a bio-silica-TiO₂ catalyst material synthesized through an atmospheric pressure low temperature plasma process according to an embodiment of the disclosure and 1 ml of hydrogen peroxide (H₂O₂) is used, it may be confirmed that an organic substance (dyeing organic substance MB) removal rate is close to 100% in a low-light solar lamp or incandescent lamp.

Referring to FIG. 13, it may be confirmed that a bio-silica-TiO₂ catalyst material synthesized through an atmospheric pressure low temperature plasma process according to an embodiment of the disclosure removes a dyeing organic substance, so that a contaminant substance solution (20 ppm solution), which initially had a dark blue color, gradually becomes transparent over time.

Referring to FIGS. 14A and 14B, it is possible to confirm experimental results showing a rate at which the bio-silica-TiO₂ catalyst material synthesized through an atmospheric pressure low temperature plasma process according to an embodiment of the disclosure decomposes organic hazardous substances generated in a semiconductor process over time.

In FIG. 14A, a decomposition ability measured at a high concentration of 20 ppm may be confirmed, and in FIG. 14B, a decomposition ability measured at an ultra-high concentration of 100 ppm may be confirmed, wherein
referring to FIGS. 14A and 14B, it may be confirmed that a bio-silica-TiO₂ catalyst material synthesized through an atmospheric pressure low-temperature plasma process according to an embodiment of the disclosure can completely decompose and remove contaminant substances by 100% in both the high concentration (20 ppm) and ultra-high concentration (100 ppm) contaminant substances in a low-intensity solar lamp or incandescent lamp, and can decompose and remove most of contaminant substances by about 70% in a low-intensity LED light source.

In FIG. 15A, a contaminant substance removal rate according to the number of repetitions measured in an environment where a dyeing organic substance exists in a high concentration of 20 ppm may be confirmed, and in FIG. 15B, a removal rate of contaminant substances according to the number of repetitions measured in an environment where a dyeing organic substance exists at an ultra-high concentration of 100 ppm may be confirmed, wherein referring to FIGS. 15A and 15B, it may be confirmed that a bio-silica-TiO₂ catalyst material synthesized through an atmospheric pressure low-temperature plasma process according to an embodiment of the disclosure does not show a decrease in a removal rate of contaminant substances even when repeated multiple times in both the high concentration (20 ppm) and ultra-high concentration (100 ppm) dyeing organic substances.

According to the above results, it may be confirmed that a bio-silica-TiO₂ catalyst material synthesized through an atmospheric pressure low temperature plasma process according to an embodiment of the disclosure may be reused multiple times in the high concentration (20 ppm) and ultra-high concentration (100 ppm) dyeing organic substances.

In FIG. 16A, a contamination substance removal rate according to the number of repetitions measured in an environment where an organic contamination substance from a semiconductor process exists at a high concentration of 20 ppm may be confirmed, and in FIG. 16B, a contamination substance removal rate according to the number of repetitions measured in an environment where an organic contamination substance from a semiconductor process exists at an ultra-high concentration of 100 ppm may be confirmed,

Referring to FIGS. 16A and 16B, it may be confirmed that a bio-silica-TiO₂ catalyst material synthesized through an atmospheric low-temperature plasma process according to an embodiment of the disclosure does not exhibit a decrease in a removal rate of contaminant substances even when repeated multiple times in both the organic contaminant substances from a semiconductor process at high concentration (20 ppm) and ultra-high concentration (100 ppm).

According to the above results, it may be confirmed that a bio-silica-TiO₂ catalyst material synthesized through an atmospheric low-temperature plasma process according to an embodiment of the disclosure may be reused multiple times in both the organic contaminant substances from a semiconductor process at high concentration (20 ppm) and ultra-high concentration (100 ppm).

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

What is claimed is:

1. A highly efficient photocatalyst material for decomposing organic hazardous substances, the highly efficient photocatalyst material comprising:
silica having nanopores formed; and
a quantum dot substance surrounding the silica,
wherein the quantum dot substance is coexistence of a TiO₂ quantum dot and a TiO₂₋ₓ quantum dot, and the X is a real number greater than 0 and less than 2.

2. The highly efficient photocatalyst material of claim 1, wherein a porosity of nanopores formed in the silica is 2 nm to 100 nm.

3. The highly efficient photocatalyst material of claim 1, wherein the TiO₂₋ₓ quantum dot comprises an oxygen defect or a hydroxyl group (—OH).

4. The highly efficient photocatalyst material of claim 1, wherein the TiO₂ quantum dot has a multi-crystal structure comprising a rutile crystal structure and an anatase crystal structure.

5. The highly efficient photocatalyst material of claim 1, wherein in the entire photocatalyst material, a ratio of the presence of the TiO₂ quantum dot and TiO₂₋ₓ quantum dot is 2:8 to 8:2.

6. The highly efficient photocatalyst material of claim 1, wherein through a Ti—O—Si bond formed by bonding of the silica and the TiO₂₋ₓ quantum dot surrounding the silica, reduction of the TiO₂₋ₓ quantum dot having a defect to the TiO₂ quantum dot in an oxygen-containing environment is suppressed.

7. The highly efficient photocatalyst material of claim 1, wherein the photocatalyst material exhibits a catalytic activity across a UV-A and visible wavelength range.

8. A method for synthesizing a highly efficient photocatalyst material for decomposing organic hazardous substances, the method comprising:
forming a bio-silica solution by dispersing bio-silica in a solvent;
adding an aqueous solution comprising a Ti³⁺ precursor to the formed bio-silica solution to form a mixed solution; and
performing a low-temperature atmospheric pressure plasma process which is applying low-temperature atmospheric pressure air plasma to the formed mixed solution.

9. The method of claim 8, wherein the forming of the bio-silica solution disperses the bio-silica in a solvent through an ultrasonic disperser.

10. The method of claim 8, wherein the forming of the mixed solution makes a mass ratio of the Ti³⁺ precursor to the bio-silica be 0.02 wt % to 20 wt %.

11. The method of claim 8, wherein in the forming of the mixed solution, an added TiCl₃ aqueous solution has a concentration of 10% to 15%.

12. The method of claim 8, wherein the performing of the low-temperature atmospheric pressure plasma process is performed for 10 minutes or less.

13. The method of claim 8, wherein the performing of the low-temperature atmospheric pressure plasma process is performing a reaction to simultaneously synthesize a TiO₂ quantum dot and a TiO₂₋ₓ quantum dot from a TiCl₃ substance, and the X is a real number greater than 0 and less than 2.

14. The method of claim 13, wherein the performing of the low-temperature atmospheric pressure plasma process makes, in the entire synthesized photocatalyst material, a ratio of the presence of the TiO₂ quantum dot and TiO₂₋ₓ quantum dot be 2:8 to 8:2.
